(19) United States
(12) Patent Application Publication
(10) Pub. No.: US 2002/0176136 A1
(43) Pub. Date: Nov. 28, 2002

(54) Remote-controlled vibrating plate

(76) Inventor: Gert Persson, Lyckeby (SE)

Correspondence Address: Walter Ottesen, Patent Attorney, P.O. Box 4026, Gaithersburg, MD, 20885-4026, US

(21) Appl. No.: 09/862,320

(22) Filed: May 23, 2001

(30) Foreign Application Priority Data
May 25, 2000 (SE) 0001951 3

(51) Int. Cl. H04B 10/00

(52) U.S. Cl. 359/142

(57) ABSTRACT

The invention is directed to an IR unit for a remote-controlled vibrating plate operated by control signals from a handheld control unit. The control signals from the control unit are transmitted to the vibrating plate (1) by infrared light. The IR eye (5) of the vibrating plate is mounted on a depressable mounting plate (6) and is protected by a spoke-shaped protective grill (13) to prevent damage to the eye from the action of an external force.

### BACKGROUND OF THE INVENTION

Remote-controlled vibrating plates are often operated by control signals from a handheld device from which the control signals to the plate are transmitted with the aid of infrared (IR) light. The receiving eye on the plate must be mounted at the highest point of the vibrating plate so that the signals are not obstructed during operation. It is important, especially when operating the vibrating plate in pipe trenches, that the overall height of the plate is as small as possible so that it can be operated, for example, under existing support rods between the sides of the trench.

### SUMMARY OF THE INVENTION

The purpose of the invention is to provide the receiving eye with a depressable mount to prevent damage to the receiving eye when operating the plate under horizontal support bars such as in a pipe trench. The invention also protects the receiving eye when lifting and handling the vibrating plate, for example, with truck forks or an excavator bucket.

This is achieved by mounting the receiving eye on a spring-loaded mounting plate provided with a spoke-shaped protective grill enclosing the receiving eye in such a manner that the grill is pressed into the housing of the vibrating plate when subjected to a mechanical load. Furthermore, the spokes of the protective grill are sloped with respect to the horizontal plane in such a manner that the grill is pressed downwardly when either a vertical or horizontal force is applied.

The IR unit of the invention is for a remote-controlled vibrating plate operated by control signals transmitted to the IR unit from a handheld portable device held by an operator. The control signals are transmitted in the form of infrared light. The IR unit is subjectable to an impact blow during operation of the vibrating plate. The IR unit of the invention includes: a mounting plate; an IR eye disposed on the mounting plate for receiving the control signals; a protective grill enclosing the IR eye; a guide arrangement mounted in the housing of the vibrating plate; the mounting plate being movably mounted on the guide arrangement so as to be movable along the guide arrangement between a first position or rest position and a second position along the guide arrangement in response to the impact blow against the protective grill; and, resilient biasing means for returning the mounting plate to the first position and for resiliently biasing the mounting plate in the first position.

### BRIEF DESCRIPTION OF THE DRAWINGS

The invention will now be described with reference to the drawings wherein:

FIG. 1 is a side elevation view of a vibrating plate with an IR eye unit;

FIG. 2 is an enlarged view of the IR eye unit shown in FIG. 1;

FIG. 3 is a plan view of the IR eye unit from above; and,

FIG. 4 is a vertical section through the IR eye unit taken along line A-A of FIG. 3.

### DESCRIPTION OF THE PREFERRED EMBODIMENTS OF THE INVENTION

FIG. 1 is a side view of a remote-controlled vibrating plate 1 with a sole plate 2 and eccentric elements 3. Reference numeral 4 indicates the upper cover of the vibrating plate through which cover the spring-loaded IR eye unit projects.

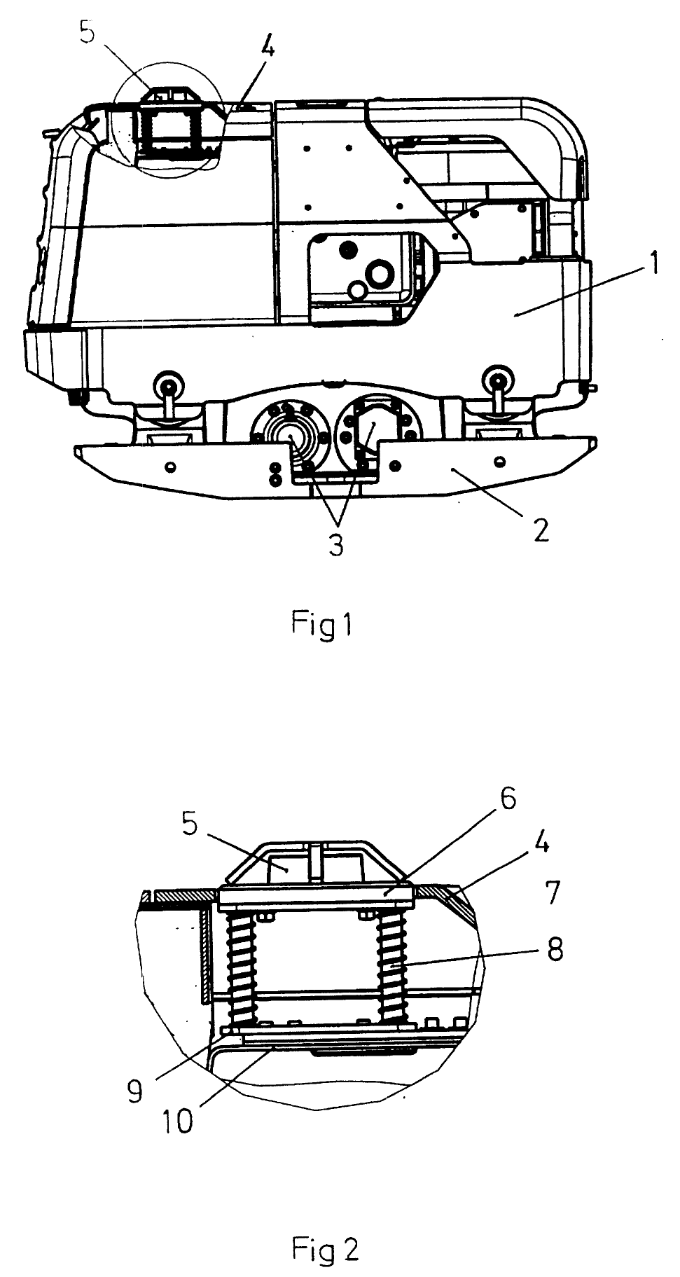

FIG. 2 shows the mounting plate 6 of the IR eye 5. The plate 6 is held in the upper position by coil springs 7 which are free to move up and down on the guide pins 8. The guide pins are attached to the plate 9 which, in turn, is mounted on the hydraulic tank 10 of the vibrating plate 1.

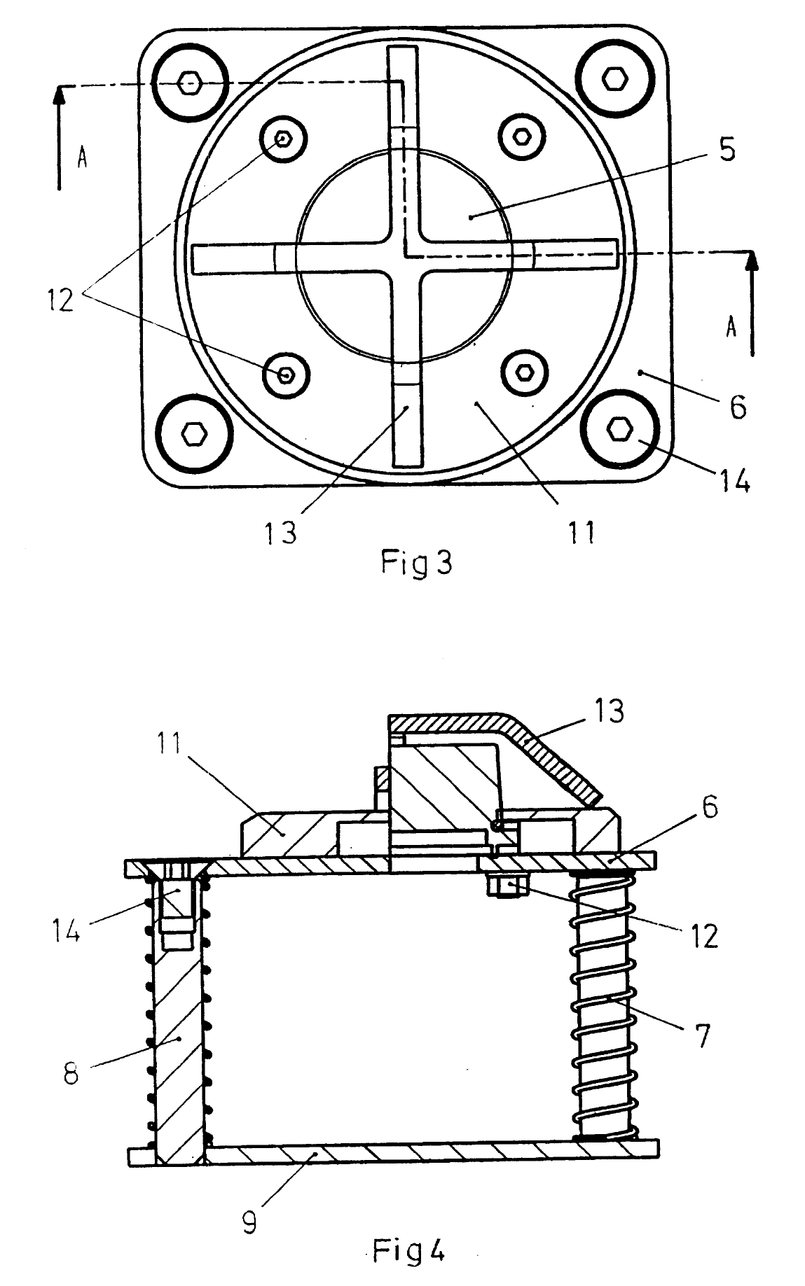

FIG. 3 is a view of the IR eye from above showing the mounting of the IR eye 5 on the mounting plate 6 by means of a circular plate 11 which is bolted to the mounting plate by bolts 12. The circular plate 11 is provided with a protective grill in the form of a spoke-shaped steel crosspiece 13 which encloses the IR eye 5 and is designed to protect the eye if obstacles are encountered.

The upper position of the mounting plate 6 is determined by the recessed screws 14 which threadably engage the guide pins 8 as shown in FIG. 4. The cylindrical part of each screw hole in the mounting plate 6 for the screws 14 is of a diameter slightly greater than the diameter of the guide pins 8 to permit the movement of the mounting plate 6 relative to the guide pins. The mounting plate 6 is resiliently biased into its upper position by the coil springs 7 which permit the mounting plate and IR eye to be moved downwardly into a protected position below the level of the vibrating plate cover 4 under the action of an external force. After the external force is removed, the coil springs return the mounting plate 6 and IR eye back to the upper position.

An external force can occur when the vibrating plate is used, for example, in a pipe trench and the IR unit bumps against a horizontal support bar bracing the side walls of the trench as the vibrating plate passes beneath the support bar.

It is understood that the foregoing description is that of the preferred embodiments of the invention and that various changes and modifications may be made thereto without departing from the spirit and scope of the invention as defined in the appended claims.

What is claimed is:

1. An IR unit of a remote-controlled vibrating plate operated by control signals transmitted to the IR unit from a handheld portable device held by an operator, the control signals being transmitted in the form of infrared light, and said vibrating plate having a housing, said IR unit being subjectable to an impact blow during operation of said vibrating plate, said IR unit comprising:
a mounting plate;
an IR eye disposed on said mounting plate for receiving said control signals;
a protective grill enclosing said IR eye;
a guide arrangement mounted in said housing;
said mounting plate being movably mounted on said guide arrangement so as to be movable along said guide arrangement between a first position or rest position and a second position along said guide arrangement in response to said impact blow against said protective grill; and,
resilient biasing means for returning said mounting plate to said first position and for resiliently biasing said mounting plate in said first position.

2. An IR unit of a remote-controlled vibrating plate operated by control signals transmitted to the IR unit from a handheld portable device held by an operator, the control signals being transmitted in the form of infrared light, and said vibrating plate having a housing, said IR unit being subjectable to an impact blow during operation of said vibrating plate, said IR unit comprising:
a plurality of guide pins mounted in said housing;
a mounting plate having a plurality of bores formed therein for slidably engaging corresponding ones of said guide pins so as to be movable along said guide pins between a first position or rest position and a second position along said guide pins in response to an impact blow against said protective grill;
a plurality of coil springs mounted on corresponding ones of said guide pins for returning said mounting plate to said first position and for resiliently biasing said mounting plate in said first position; and,
a plurality of stops mounted on corresponding ones of said guide pins to fix said first position.

3. The IR unit of claim 2, wherein each of one of said plurality of stops has a diameter greater than the bore in said mounting plate corresponding thereto.

4. The IR unit of claim 3, wherein each of said stops is a bolt having a beveled head and said bores are correspondingly beveled so that said bolts lie flush with the top surface of said mounting plate when said mounting plate is in said first position.
